(19) United States
(12) Patent Application Publication
(10) Pub. No.: US 2010/0106129 A1
(43) Pub. Date: Apr. 29, 2010

(54) CONTROLLED FORCE MECHANISM FOR A FLUID CONNECTOR

(75) Inventors: Bruce A. Goeckner, Antioch, IL (US); Edwin Chim, Vernon Hills, IL (US)

Correspondence Address: K&L Gates LLP, P.O. Box 1135, Chicago, IL, 60690-1135, US

(73) Assignees: BAXTER INTERNATIONAL INC., Deerfield, IL (US); BAXTER HEALTHCARE S.A., Zurich (CH)

(21) Appl. No.: 12/258,127

(22) Filed: Oct. 24, 2008

(51) Int. Cl. A61J 1/20

(52) U.S. Cl. 604/411

(57) ABSTRACT

A piercing assembly for a fluid connector, where the piercing assembly includes a piercing member, a hub that supports the piercing member, and a disk-shaped flange connected to the hub. The disk shaped flange includes a plurality of arms. At least a portion of an outer surface of the arms is curved to enable the piercing assembly to slide within a portion of the tubular fluid connector. The arms of the flange may be formed in a curved shape, an S-shape, a tab shape or in a maze-like configuration. The arms may also be defined by a plurality of cuts or slits formed into the flange. The arms of the flange are sized to engage one or more flanges on the inside of the fluid connector when the fluid connector is in an activated state.

### CROSS REFERENCE TO RELATED APPLICATIONS

This application is related in subject matter to copending U.S. patent application Ser. No. 10/744,953, filed Dec. 23, 2003, which is a continuation-in-part application of U.S. patent application Ser. No. 10/106,716, filed Mar. 26, 2002, which is a continuation-in-part application of U.S. patent application Ser. No. 09/561,666, filed May 2, 2000, which is a continuation application of U.S. patent application Ser. No. 09/153,816, filed Sep. 15, 1998, now U.S. Pat. No. 6,113,583, patented Sep. 5, 2000, which applications are incorporated herein by reference and made a part hereof.

### BACKGROUND

Many drugs are unstable even for a short period of time in a dissolved state and therefore are packaged, stored, and shipped in a powdered or lyophilized state to increase their shelf life. In order for powdered drugs to be given intravenously to a patient, the drugs must first be placed in liquid form. To this end, these drugs are mixed or reconstituted with a diluent before being delivered intravenously to a patient. The diluents may be, for example, a dextrose solution, a saline solution, or even water. Typically the drugs are stored in powdered form in glass vials or ampules.

Other drugs, although in a liquid state, must still be diluted before administering to a patient. For example, some chemotherapy drugs are stored in glass vials or ampules, in a liquid state, but must be diluted prior to use. As used herein, reconstitution means to place the powdered drug in a liquid state, as well as, the dilution of a liquid drug.

The reconstitution procedure should be performed under sterile conditions. In some procedures for reconstituting, maintaining sterile conditions is difficult. Moreover, some drugs, such as chemotherapy drugs, are toxic and exposure to the medical personnel during the reconstitution procedure can be dangerous. One way of reconstituting a powdered drug is to inject the liquid diluent directly into the drug vial. This can be performed by use of a combination-syringe and syringe needle having diluent therein. In this regard, drug vials typically include a pierceable rubber stopper. The rubber stopper of the drug vial is pierced by the needle, and liquid in the syringe is then injected into the vial. The vial is shaken to mix the powdered drug with the liquid. After the liquid and drug are mixed, a measured amount of the reconstituted drug is then drawn into the syringe. The syringe is then withdrawn from the vial and the drug can then be injected into the patient. Another method of drug administration is to inject the reconstituted drug, contained in the syringe, into a parenteral solution container. Examples of such containers include a MINI-BAG.™. flexible parenteral solution container or VIAFLEX.®. flexible parenteral solution container sold by Baxter Healthcare Corporation of Deerfield, Ill. These parenteral solution containers may already have therein dextrose or saline solutions. The reconstituted drug is injected into the container, mixed with the solution in the parenteral solution container and delivered through an intravenous solution administration set to a vein access site of the patient.

Another method for reconstituting a powdered drug utilizes a reconstitution device sold by Baxter Healthcare Corporation, product code No. 2B8064. That device includes a double pointed needle and guide tubes mounted around both ends of the needle. This reconstitution device is utilized to place the drug vial in fluid communication with a flexible-walled parenteral solution container. Once the connection is made by piercing a port of the flexible container with one end of the needle and the vial stopper with the other end of the needle, liquid in the solution container may be forced through the needle into the drug vial by squeezing the sidewalls of the solution container. The vial is then shaken to mix the liquid and drug. The liquid in the vial is withdrawn by squeezing air from the solution container into the vial. When compression of the flexible walled solution container is stopped, the pressurized air in the vial acts as a pump to force the liquid in the vial back into the solution container.

An improvement to this product is the subject of commonly assigned U.S. Pat. No. 4,607,671 to Aalto et al. The device of the '671 patent includes a series of bumps on the inside of a sheath to grip a drug vial. These bumps hinder the inadvertent disconnection of the device with the vial.

U.S. Pat. No. 4,759,756 discloses a reconstitution device which, in an embodiment, includes an improved vial adaptor and bag adaptor that permit the permanent coupling of a vial and liquid container. The bag adaptor is rotatable relative to the vial adaptor to either block fluid communication in a first position or effect fluid communication in a second position.

Another form of reconstitution device is seen in commonly assigned U.S. Pat. No. 3,976,073 to Quick et al. Yet another type of reconstitution device is disclosed in U.S. Pat. No. 4,328,802 to Curley et al., entitled “Wet-Dry Syringe Package” which includes a vial adaptor having inwardly directed retaining projections to firmly grip the retaining cap lip of a drug vial to secure the vial to the vial adaptor. The package disclosed by Curley et al. is directed to reconstituting a drug by use of a liquid-filled syringe.

Other methods for reconstituting a drug are shown, for example, in commonly assigned U.S. Pat. No. 4,410,321 to Pearson et al., entitled “Close Drug Delivery System”; U.S. Pat. Nos. 4,411,662 and 4,432,755 to Pearson, both entitled “Sterile Coupling”; U.S. Pat. No. 4,458,733 to Lyons entitled “Mixing Apparatus”; and U.S. Pat. No. 4,898,209 to Zdeb entitled “Sliding Reconstitution Device With Seal.”

Other related patents include U.S. Pat. No. 4,872,867 to Kilinger entitled “Wet-Dry Additive Assembly”; U.S. Pat. No. 3,841,329 to Kilinger entitled “Compact Syringe”; U.S. Pat. No. 3,826,261 to Kilinger entitled “Vial and Syringe Assembly”; U.S. Pat. No. 3,826,260 to Kilinger entitled “Vial and Syringe Combination”; U.S. Pat. No. 3,378,369 to Kilinger entitled “Apparatus for Transferring Liquid Between a Container and a Flexible Bag”; and German specification DE OS 36 27 231.

Commonly assigned U.S. Pat. No. 4,898,209 to Zdeb (the '209 Patent), discloses a sliding reconstitution device which solved some of the problems discussed above. For example, the connector allowed for preattaching the device to a vial without piercing a closure of the vial. However, no seal was provided on the opposite end of the connector so the vial and device assembly had to be used immediately after connection or stored in a sterile environment, such as under a hood.

The '209 Patent discloses a first sleeve member that is mounted concentrically about a second sleeve member. The sleeve members can be moved axially with respect to each other to cause a needle or cannula to pierce a drug container and a diluent container to place the containers in fluid communication with each other.

The process for using the '209 connector required three distinct steps. The sleeves had to be rotated with respect to one another to move the device into an unlocked position. The sleeves were then moved axially with respect to one another to an activated position to pierce closures of the containers. The sleeves had to be rotated again to lock the sleeves in the activated position.

However, it is possible for the device of the '209 Patent to be easily and inadvertently disassembled when being moved to the activated position. The second sleeve is capable of sliding entirely though the first sleeve member and becoming disassociated into separate parts. This would require the medical personnel to either reassemble the device or dispose of it due to contamination.

Also, the device of the '209 Patent did not provide for a visual indication that the device was in the activated position. It was also possible for the device to be inadvertently moved to the inactivated position, by rotating the first and second sleeve members in a direction opposite of the third step described above.

Additionally, it was possible for the second container, which is frequently a vial, to rotate within the device. This could cause coring of the vial stopper which could lead to leakage of the vial stopper. Additionally it was possible for a vial to be misaligned while being attached to the device causing the attachment process to be difficult for medical personnel. Further, the connector only releasably attached to the vial. Removal of the vial could remove all tamper evident indications that the reconstitution step has occurred and could lead to a second unintended dosage of medicine to be administered. Finally, the seal had a sleeve that covered only a portion of the cannula. The sleeve of the seal was relatively resilient and had the tendency of pushing the connector away from the drug container when docked thereto.

Yet another connector for attaching a drug vial to a parenteral solution container is disclosed in U.S. Pat. No. 4,675,020 (“the '020 patent”). The '020 patent discloses a connector having an end that docks to a drug vial and an opposite end that connects to the solution container. A shoulder and an end surface of the vial are held between first and second jaws of the vial end of the connector. The second jaws 71 terminate in a relatively sharp point that digs into and deforms the outermost end surface 94 of the vial sufficiently to accommodate dimensional variations between the shoulder and the outermost end surface of the vial. The marks that are left in the deformable end surface of the vial are intended to provide a tamper evident feature. However, tamper evident marks will not be left in vials that have a cap that is too short to impinge upon the sharp points.

The connector has a spike 25 that penetrates stoppers on the vial and on the solution container to place these containers in fluid communication. However, because the spike 25 extends outward beyond skirt sections 57, the connector of the '020 patent cannot be preattached to the fluid container or the drug container without piercing the stoppers of each. (The '020 patent states that the connector may be preassembled onto a drug vial, but there is no explanation of the structure of such a device. (Col. 6, lines 40-49)). This is undesirable as it initiates the time period in which the drug must be used, and typically this is a short period relative to the normal shelf-life of the product.

Also, the connector of the '020 patent does not provide a structure for preventing a docked vial from rotating. A closure of the vial can become damaged or cored upon rotation, which in turn, can lead to particles from the closure from entering the fluid that eventually passes to a patient. It can also lead to leakage of the closure of the vial.

Another connector for attaching a drug vial to a flexible container is disclosed in commonly assigned U.S. patent application Ser. No. 08/986,580, now U.S. Pat. No. 6,071,270. This connector has a piercing member mounted between two sleeves slidably mounted to one another. The bag connecting end is sealed by a peelable seal material. The seal material must be removed before connecting to the flexible container. Removal of the seal material exposes the piercing member to the outside environment thereby breaching the hermetic seal of the piercing member.

Another connector for attaching a drug vial to a flexible solution container is disclosed in U.S. Pat. No. 5,352,191 (“the '191 Patent”). The connector has a communicating portion having a communicating passage disposed at a top portion of the flexible container wherein one end of the communicating portion extends into the flexible container. The drug vial is fitted partially or wholly into an opposite end of the communicating portion. A membrane is disposed in the communicating passage for closing the passage. The connector also includes a puncturing needle unit mounted in the communicating passage for enabling the drug vial and flexible container to communicate with each other. When the puncturing needle unit is pressed externally through the flexible container, the needle breaks the membrane and opening of the drug vial to enable the drug vial and container to communicate with each other.

U.S. Pat. No. 5,380,315 and EP 0843992 disclose another connector for attaching a drug vial to a flexible solution container. Similar to the '191 patent, this patent and patent application have a communication device in the form of spike that is mounted within the flexible container. The communication device is externally pressed towards a drug vial to puncture the drug vial and communicate the drug vial with the flexible container.

U.S. Pat. No. 5,478,337 discloses a device for connecting a vial to a flexible container. This patent requires the vial to be shipped pre-assembled to the connector, and, therefore, does not allow for medical personnel to selectively attach a vial to the connector.

Finally, U.S. Pat. No. 5,364,386 discloses a device for connecting a vial to a medical fluid container. The device includes a screw cap 32 that must be removed before inserting the vial. Removing the screw cap, however, potentially exposes the piercing member 48 to contaminants as the piercing member is not hermetically sealed.

While the reconstitution devices of the prior art provide a number of advantageous features, they nevertheless have certain limitations.

### SUMMARY

The present disclosure provides a fluid reconstitution device for placing a first container, such as a diluent or liquid container (e.g. flexible container or syringe), in fluid communication with a second container, such as a drug vial. To this end, there is provided a connector device for establishing fluid communication between the liquid container and the drug vial. The connector has a piercing member having a first end and a second end and a central fluid pathway. The piercing member is mounted to the liquid container and has fluid accessing portions hermetically sealed from an outside environment. A vial receiving chamber is associated with the piercing member and is dimensioned to connect to the vial. The vial may be selectively attached to the device without piercing the closure of the vial and without breaching the hermetic seal of the fluid accessing portions of the piercing member. Means are provided for connecting the vial receiving chamber to the liquid container. The device is movable from an inactivated position, where the piercing member is outside the sidewalls and no fluid flows between the liquid container and the drug vial, to an activated position, where fluid flows through the fluid pathway between the liquid container and the drug vial. The device is movable from the inactivated position to the activated position by a force applied to the device outside the liquid container.

In an embodiment, the piercing assembly includes a piercing member and a hub supported on the piercing member. The hub is dimensioned to allow movement of the piercing assembly from a first position to a second position, wherein an outer surface of the hub is forced past a protuberance or flange formed inside the fluid connector. When the fluid connector device is moved from the activated position to a deactivated position, the protuberance or flange restricts the hub from returning to the first position. In one embodiment, the hub is a flat disc, in which the outside edge of the disc corresponds to at least a portion of the inside surface of the connector device.

In an embodiment, the hub of the piercing assembly is not a solid flat disc, but includes a plurality of arms extending from a central portion of the hub. The arms provide increased flexibility to the hub relative to the flexibility of a flat disc shaped hub. The added flexibility lessens the amount of force that is required to push the outer edge of the hub past the flange when moving the device from the inactivated position to the activated position.

In one embodiment in which the hub includes a plurality of arms, the arms extend from a central portion of the hub. A first portion of the arms extends radially outwardly from the central portion, and a second portion of the arms extends circumferentially about a central axis of the hub. The arms include curved outer surfaces that can be circular and can slide along the inner surface of the connector device. As the connector device is moved to the activated position, the outer surface of the hub slides past the flanges of the fluid connector. The arms are configured such that gaps are formed between adjacent arms. Each of the arms includes an extension or tab that is configured to engage with one of the flanges.

In one embodiment in which the hub includes a plurality of arms, the arms extend from the central portion. The overall shape of the hub is generally disk-shaped, but the hub is not a solid disk. Each of the plurality of arms includes a first portion that extends radially outwardly from the central portion of the hub, and a second portion that extends from one side of the first portion, and circumferentially about the central axis. The outer surfaces of the arms are curved to give the outer perimeter of the hub a circular shape. In this embodiment, the arms do not include a protuberance or an extension to engage with an annular flange. Rather, the outer curved surfaces engage one or more flanges on the inside of the connector housing. In an embodiment, the connector housing includes a plurality of flanges and the hub is engageable with the flanges at a plurality of locations on the outer circular perimeter of the hub.

In one embodiment in which the hub includes a plurality of arms, the arms are arches that are centered about the central portion of the hub. Each of the arches is connected to the central portion by portions or arms that extend radially outwardly from the central portion of the hub. The arches have a curved or circular outer surface and collectively form a continuous ring. The arches also have a curved inner surface and the combination of the arches, the central portion, and the extending first portions, form a spoke and rim configuration for the hub. The arches flex up and down as the hub travels past one or more flanges inside the connector device. In an embodiment, each of the arches is split such that each arch has a right portion and a left portion that can interlock together.

In one embodiment in which the hub includes a plurality of arms, the hub is substantially disk-shaped and includes a plurality of cuts or recesses or slits that extend radially inwardly from an outer surface of the hub a partial distance toward the central portion of the hub. Fingers are formed between successive slits. The slits may be curved or straight.

In one embodiment in which the hub includes a plurality of arms, the arms are arranged in a flexible maze-like configuration. The hub includes a central portion and plurality of winding or traversing arms extending from the central portion. The overall shape of the hub is generally disk-shaped, but is not a solid disk. Each of the arms includes several portions that wind back and forth circumferentially about the central axis of the hub. The number of windings can be two or more for example. The outer surface of the outermost winding is curved such that the overall outer perimeter of the hub is generally circular. The outer circular perimeter enables the hub to slide through the interior of the fluid connector device when the device is moved between the activated and inactivated positions. The maze-like or winding configuration of the arms defines gaps or spaces in the hub that provides the hub with an increased level of flexibility or deformability when the hub is forced past the one or more flanges of the fluid connector device.

Additional features and advantages are described herein, and will be apparent from, the following Detailed Description and the figures.

### BRIEF DESCRIPTION OF THE FIGURES

FIG. 1 is a cross-sectional elevation view of a connector device in an embodiment;

FIG. 2 is a cross-sectional perspective view of the connector device in an embodiment;

FIG. 3 is an enlarged partial cross-sectional view of a port connector assembly of the connector device of FIG. 1;

FIG. 4 is a partial cross-sectional view of the connector device of an embodiment attached to a flexible container;

FIG. 5 is a partial cross-sectional view of the connector device of an embodiment having a drug vial fixedly secured to the connector device, the connector device being in an inactivated position;

FIG. 6 is a partial cross-sectional view of the connector device shown in FIG. 5 wherein the connector device is in the initial stages of a activation process;

FIG. 7 is a partial cross-sectional view of the connector device in an activated position;

FIG. 8 is a partial cross-sectional view of the connector device in a deactivated position;

FIG. 9 is a perspective view of a piercing assembly in an embodiment;

FIG. 10 is a front view of a hub of the piercing assembly shown in FIG. 9 where the hub includes a plurality of arms;

FIG. 11 is a perspective view of a piercing assembly in an embodiment;

FIG. 12 is a front view of a hub of the piercing assembly shown in FIG. 11 where the hub includes a plurality of arms;

FIG. 13 is a perspective view of a piercing assembly in an embodiment;

FIG. 14 is a front view of a hub of the piercing assembly shown in FIG. 13 where the hub includes a plurality of arches;

FIG. 15 is a front view of a hub of the piercing assembly shown in FIG. 13 where the hub includes a plurality of arches having interlocking ends;

FIG. 16 is a perspective view of a piercing assembly in an embodiment;

FIG. 17 is a front view of a hub of the piercing assembly shown in FIG. 16 where the hub has a plurality of recesses;

FIG. 18 is a perspective view of a piercing assembly in an embodiment; and

FIG. 19 is a front view of a hub of the piercing assembly shown in FIG. 18 where the hub includes a plurality of arms.

### DETAILED DESCRIPTION

While the embodiment may be in many different forms, there is shown in the drawings and will herein be described in detail preferred embodiments. It is to be understood that the present disclosure is to be considered as an exemplification of the principles of the embodiments. This disclosure is not intended to limit the broad aspect of the invention to the illustrated embodiments.

The present disclosure provides a connector device that is used to mix two substances within separate containers. More particularly, an embodiment provides a device to reconstitute a drug with a diluent. To accomplish the reconstitution of the drug, the embodiment provides an improved connecting device for attaching to a first container, commonly a flexible bag or a syringe, containing a diluent, to a second container, commonly a vial containing a drug to be reconstituted. The connector provides fluid communication between the two containers through a hermetically sealed piercing member so that the drug may be reconstituted, and delivered to a patient. What is meant by hermetically sealed is that the portions of the piercing member that contact the fluid and that pierce the closures of the two containers are sealed from the outside environment.

While the diluent will be a liquid, the beneficial agent may be either a powder or a lyophilized drug to be dissolved or a liquid drug to be reduced in concentration. The devices of the present embodiment provide the benefit of allowing medical personnel to selectively attach a vial of their choice to the connector. Thus, hospitals and pharmacies do not have to stock pre-packaged drug vial and connector assemblies. Further, the connectors of the present embodiments allow for docking a vial to the connector without breaching the hermetic seal of a piercing member associated with the connector and without piercing the closure of the vial. Thus, a vial may be pre-docked to the device of the present embodiment for essentially the full period the drug is active. Further, the device of the present embodiment can be activated by applying a force directly to the connector without necessarily contacting sidewalls of the first and second containers.

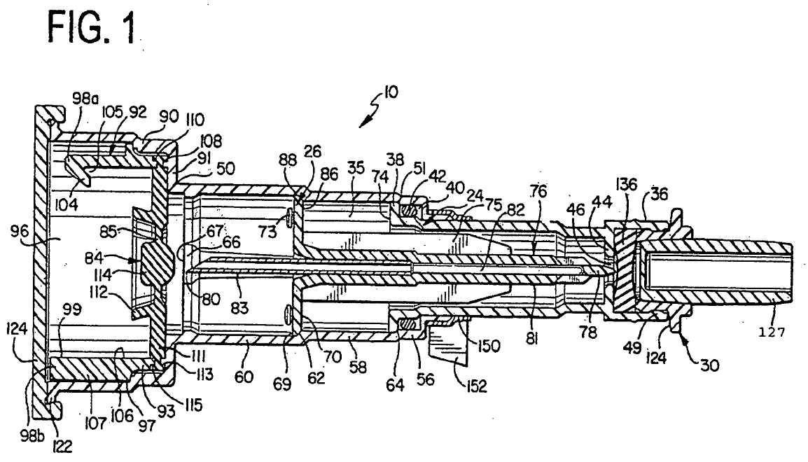

Referring to FIGS. 1, 2 and 4, a connector device is disclosed and generally referred to with the reference numeral 10. The device 10 is adapted to place a first container 12, containing a liquid to be used as a diluent, in fluid communication with a second container 14, containing a drug to be diluted or reconstituted.

The first container 12 is typically a flexible bag and is used to contain solutions for a patient to be received intravenously. Flexible containers are typically constructed from two sheets of a polymeric material forming sidewalls that are attached at their outer periphery to define a fluid tight chamber therebetween. In an embodiment, the fluid container is a coextruded layered structure having a skin layer of a polypropylene and a radio frequency susceptible layer of a polymer blend of 40% by weight polypropylene, 40% by weight of an ultra-low density polyethylene, 10% by weight of a dimer fatty acid polyamide and 10% by weight of a styrene-ethylene-butene-styrene block copolymer. These layered structures are more thoroughly set forth in commonly assigned U.S. Pat. No. 5,686,527 which is incorporated herein by reference and made a part hereof. At one point on the periphery of the container 12 a tubular port 16 is inserted between the sidewalls to provide access to the fluid chamber. A second port 18 is shown for allowing access by a fluid administration set to deliver the reconstituted drug to a patient. However, the first container 12 can be any type of container, including, for example, a syringe barrel, suitable for containing a liquid to be used to reconstitute a drug.

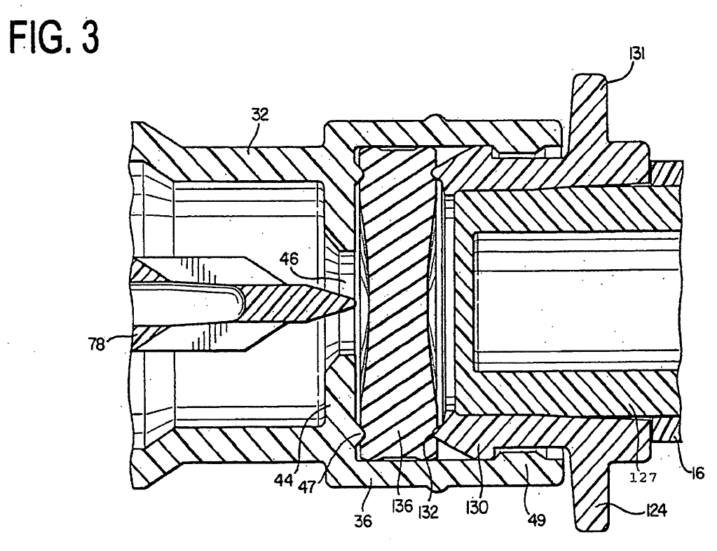

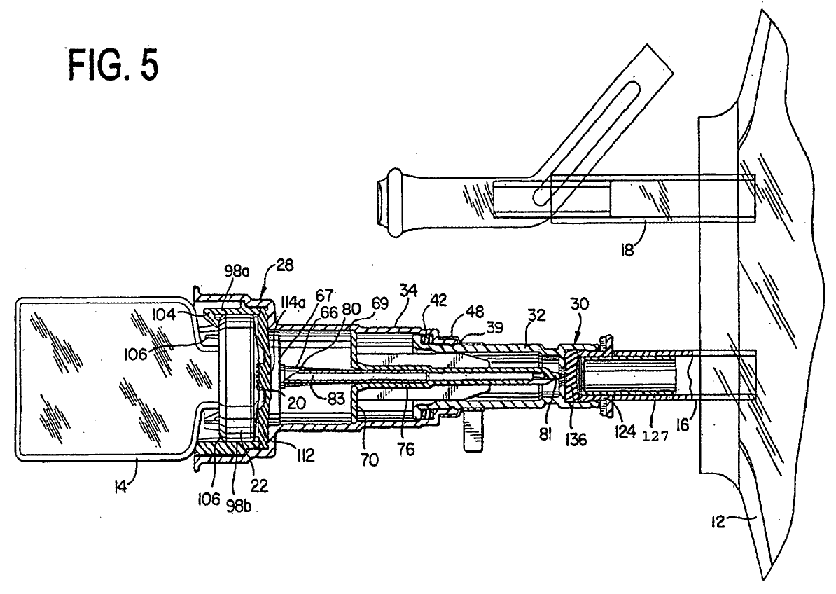

The second container 14 (FIG. 5), which contains a drug to be reconstituted, is a vial. The vial 14 is typically a glass container with a closure member. The closure member may include a rubber stopper 20 and may also have a crimp ring 22. The rubber stopper 20 is inserted in an opening of the vial 14. The rubber stopper 20 is held in place by the crimp ring 22 (FIG. 3), typically made of soft metal such as aluminum, that is crimped around the stopper 20 and the neck of the vial 14 to fixedly attach the stopper 20 to the vial 14. The crimp ring 22 has an aperture to define a target site on the rubber stopper 20. The device 10 can be adapted to accept vials of any size, particularly 20 mm and 13 mm vials. Additionally, the second container 14 can be any container that is adapted to accommodate drugs that require reconstitution.

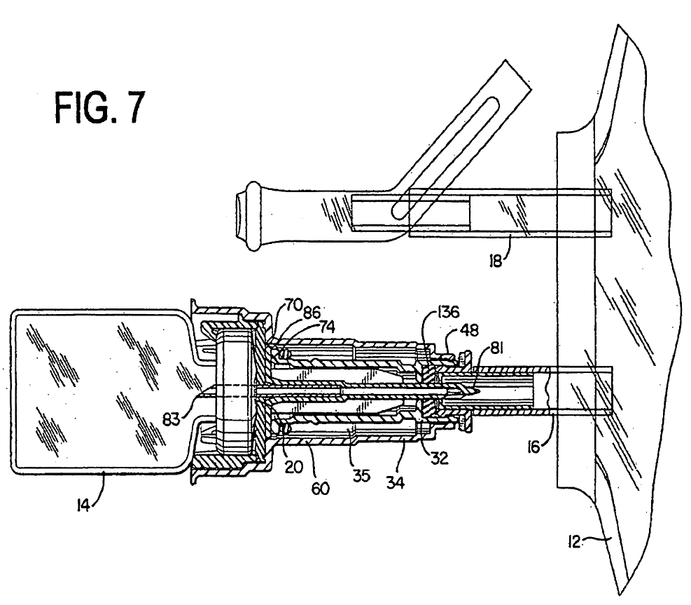

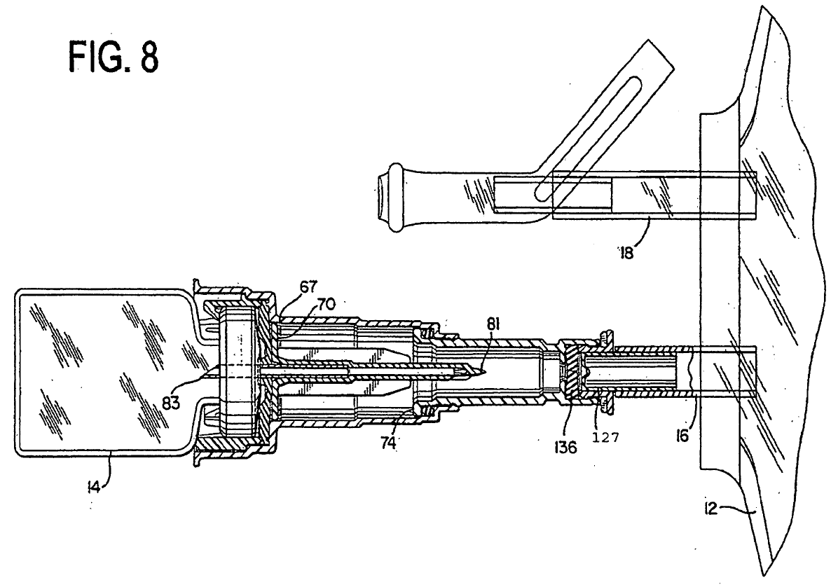

The connector 10, as stated above, is adapted to connect to both the flexible bag 12 and the vial 14 and place the contents of the flexible bag 12 and the vial 14 into fluid communication with one another. As shown in FIGS. 1, 2 and 4, the connector 10 generally comprises a sleeve assembly 24, a piercing assembly 26, a gripper assembly 28 and a port connector assembly 30. As described in greater detail below, the gripper assembly 28 and one portion of the sleeve assembly 24 are collectively adapted for axial movement with respect to another portion of the sleeve assembly 24 from an inactivated position (e.g., FIG. 5) to an activated position (FIG. 7). What is meant by the inactivated position is that the containers 12,14 are not in fluid communication with each other wherein the connector 10 has not been activated. What is meant by the activated position is that the containers 12,14 are placed in fluid communication with each other. What is meant by the deactivated position, or post reconstitution position, is the first container 12 and the second container 14 are not in fluid communication and have been moved from the activated position to the deactivated position (FIG. 8).

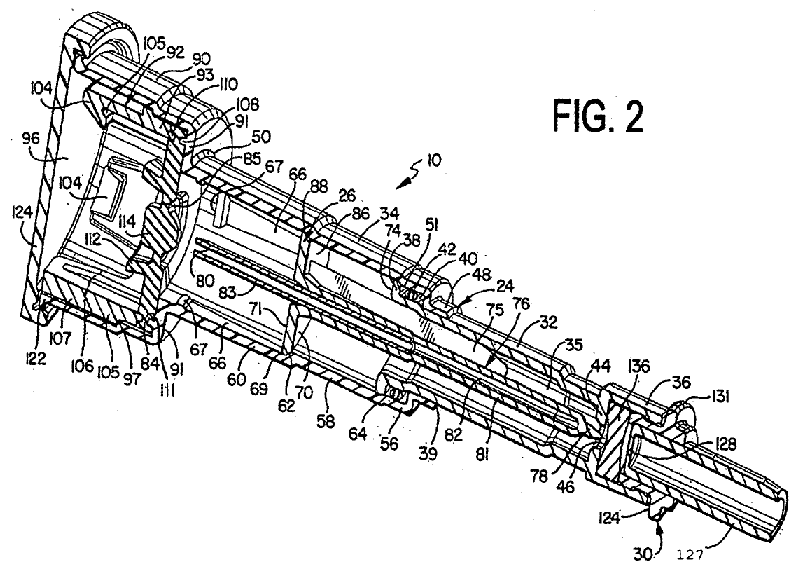

As is further shown in FIGS. 1 and 2, the sleeve assembly 24 generally comprises a first sleeve 32 and a second sleeve 34. The first sleeve 32 and second sleeve 34 are mounted for translational motion with respect to one another from the inactivated position to the activated position. In an embodiment, the first sleeve 32 is slidably mounted within the second sleeve 34. Each sleeve 32,34 has generally cylindrical walls and, collectively, the sleeves 32,34 define a central passageway 35 through the connector 10. The first sleeve 32 may also be referred to as a port adapter sleeve. The second sleeve 34 may also be referred to as a gripper housing sleeve.

The first sleeve 32 has a first end 36 and a second end 38. The first end 36 is adapted to receive and be connected to the port connector 30 as described in greater detail below. The second end 38 of the first sleeve 32 has a partial annular groove 40. The annular groove 40 receives a scaling member 42, preferably in the form of an o-ring. The sealing member 42 provides a seal between the first sleeve 32 and the second sleeve 34 and in an embodiment is disposed between the first sleeve 32 and the second sleeve 34. Of course, other sealing members such as gaskets, washers and similar devices could be used to achieve a seal between the sleeves 32,34 as is well known in the art and without departing from the present embodiment. Optionally, the second sleeve 34 could incorporate the annular groove 40 for retaining the sealing member 42. The first sleeve 32 further has a guide 44 at an inner surface of the sleeve 32, intermediate of the first end 36 and the second end 38. The guide 44 has an opening 46 adapted to receive a portion of the piercing assembly 26 during activation. As shown in FIG. 3, a projection 47 extends from the guide 44. An inner surface of the first sleeve 32 has a ramped protrusion 49 extending preferably around a full periphery of the inner surface. The protrusion 49 will cooperate with the port connector assembly 30 as described below.

Additionally, as shown in FIGS. 1 and 2, the first sleeve 32 has a stop surface 51 that cooperates with a stop surface in the form of the second ledge 64 on the second sleeve 34 to prevent the first sleeve 32 from sliding out of the second sleeve 34. The first sleeve 32 also has a stop surface 74 that interfaces with the piercing assembly 26, as will be described in greater detail below. Finally, as shown in FIG. 2, the first sleeve has a detent 39 on its outer surface. The detent 39 cooperates with an end of the second sleeve 34 which maintains the device in the inactivated position. It is understood that the second ledge 64 could be removed if desired and that portion of the second sleeve 34 could be tapered. As can be seen in FIGS. 1 and 2, additional structure in the form of an additional ledge on the second sleeve 34 will still prevent the first sleeve 32 from sliding out of the second sleeve 34.

As shown in FIGS. 1 and 2, the second sleeve 34 also has a first end 48 and a second end 50. The second end 50 of the second sleeve 34 is connected to the gripper assembly 28. In a preferred embodiment, the gripper assembly 28 is an integral portion of the second sleeve 34 although it could be separately attached. It is further understood that the gripper assembly 28, and portions thereof, can be considered as a component of the second sleeve 34. The second sleeve 34 accommodates the piercing assembly 26 within the central passageway 35. The piercing assembly 26 is slidable within the central passageway 35 along an inner surface of the second sleeve 34. Also, as shown in FIG. 2, the second sleeve 34 has a first section 56, a second section 58, and a third section 60. The third section 60 has a larger diameter than the second section 58, and the second section 58 has a larger diameter than the first section 56. At the interface between the second section 58 and the third section 60, a first ledge 62 is formed, and at the interface between the second section 58 and the first section 56, the second ledge 64 is formed. Additionally, the second sleeve 34 has a ramped protuberance 66 on an inner surface of the second sleeve 34. As shown in FIG. 2, the ramped protuberance 66 may begin proximate the ledge 62 and advance towards the second end 50 of the second sleeve 34 wherein it forms a flange 67. The ramped protuberance 66 may also have a shorter construction as shown in FIG. 1. In an embodiment, a plurality of ramped protuberances 66 are utilized and in another embodiment, four ramped protuberances 66 are spaced around the inner surface of the second sleeve 34. When a semi-resilient disk, in the form of a hub on the piercing assembly 26, as explained below, moves past the ramped protuberance 66, the semi-resilient disk cannot return past the flanges 67. The third section 60 of the second sleeve 34 further has a hub stop surface 69 that maintains the piercing assembly 26 at an initial first position before the device 10 is placed in the activated position. As further shown in FIG. 1, the second sleeve 34 has a plurality of projections 73. The projections 73 are tapered and designed to abut against the hub of the piercing assembly 26 when the device 10 is in the inactivated position. This prevents the piercing assembly from rattling during shipment and maintains the piercing assembly 26 and sealing member 84 in spaced relation in the inactivated position. As explained in greater detail below, the piercing assembly 26 will move past the projections 73 when the device is moved from the inactivated position to the activated position.

As further shown in FIGS. 1 and 2, the piercing assembly 26 generally comprises the hub 70 which supports a piercing member 76. The piercing assembly 26 is generally positioned within the sleeves 32,34 and can be considered as projecting from the sleeves 32,34. The piercing member 76 has a first end 78 that is positioned to pass through the opening 46 of the guide 44 of the first sleeve 32 upon activation. A second end 80 of the piercing member 76 is positioned adjacent the gripper assembly 28 when in the inactivated position. The piercing member 76, such as a cannula or needle, is a rigid, elongate, spiked member at each end 78,80 having a central fluid passage 82 for establishing a fluid flow passage between the first container 12 and the second container 14. The piercing member is positioned outside the sidewalls of the first container 12. Each end 78,80 of the piercing member 76 terminates in a sharp point or an oblique angle or bevel adapted to pierce through closures as will be described below. Alternatively, the piercing member 76 can have other end configurations known in the art. In a preferred embodiment, the piercing member 76 comprises a plastic spike 81 at the end 78 and a metal cannula 83 at the end 80. The spike 81 can be integrally molded with the hub 70. The metal cannula 83 preferably fits within the spike 81 and may be formed from stainless steel. The metal cannula 83 may be adhesively bonded to the hub 70 and plastic spike 81. The plastic spike 81 is positioned to pierce into the port 16 of the flexible container 12. The metal cannula 83 is positioned to pierce the vial 14. The piercing assembly 26 further has a plurality of wings 75 that extend along the piercing member 76. The wings 75 act as guides to assure the plastic spike 81 is properly aligned to pass through the opening 46 of the guide 44 on the first sleeve 32. In a preferred embodiment, four wings 75 are spaced around the piercing member 76. The hub 70 further has a top surface 71.

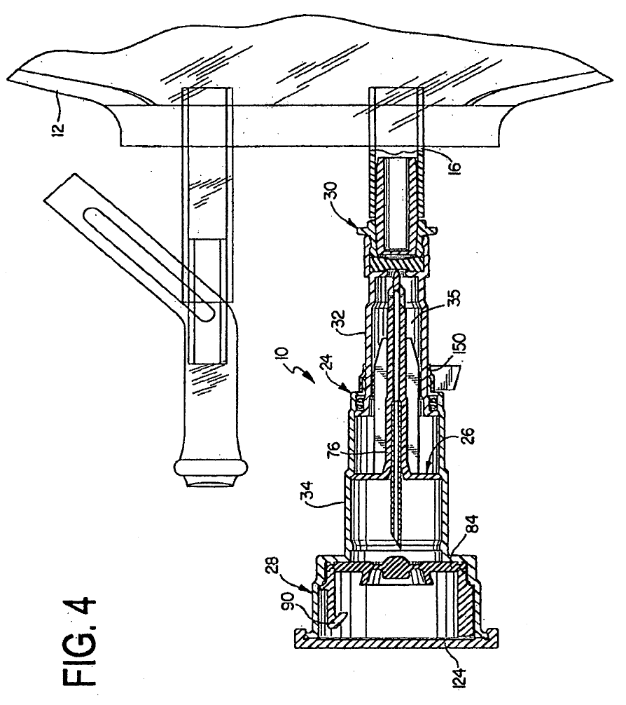

As further shown in FIGS. 1 and 2, the hub 70, connected to the piercing member 76, is slideable within the central passageway 35 along an inner surface of the second sleeve 34. In an embodiment, the hub 70 is generally round or disk-shaped. Preferably, the hub 70 has a greater diameter than the diameter of the second section 58 of the central passageway 35 but a slightly smaller diameter than the third section 60. When activating, the piercing member 76 is allowed to move and pierce the stopper 20 of the drug vial 14 and a sealing member 84 (described below) adjacent the second container 14 when the connector 10 moves from the inactivated position to the activated position. The hub 70 has a stop surface 86 that cooperates with the stop surface 74 of the first sleeve 32. When the device 10 is in the inactivated position, the stop surface 86 cooperates with the ledge 62 (FIGS. 2 and 4) on the second sleeve 34, and the top surface 71 of the hub 70 cooperates with the hub stop surface 69, which keeps the piercing assembly 26 in a first position. The hub 70 further has a curved outer surface 88 that slides along the inner surface of the second sleeve 34 and specifically along the ramped protrusions 66. The metal cannula 83 and plastic spike 81 may have a lubricant applied thereto to help facilitate insertion into the respective containers 12,14.

FIGS. 1 and 2 further show the gripper assembly 28 attached to the second sleeve 34. As discussed, in the preferred embodiment, the gripper assembly 28, or portions thereof, is integrally attached to the second end 50 of the second sleeve 34. The gripper assembly 28 could also be considered as part of the second sleeve 34. The gripper assembly 28 serves as a second attaching member to connect the vial 14 to the device 10. The gripper assembly 28 generally includes a wall portion 90, a base 91, a finger assembly 92, and a sealing member 84. The finger assembly 92 may also be referred to as a gripper ring. The gripper assembly 28 serves as an attaching member that is adapted to attach the device 10 to the second container or drug vial 14. The gripper assembly 28 has a central opening 96. The wall portion 90 is preferably annular and forms a cup-like shape in cooperation with the base 91. The wall portion 90 is preferably continuous and solid. It is understood that the gripper assembly 28 could simply include a finger structure, integral with or separately attached to the second sleeve 34, that is dimensioned to attach to a second container 14. It is further understood that the gripper assembly 28 can take various forms that serve to attach to the second container 14.

Referring again to FIGS. 1 and 2, the wall portion 90 supports means for fixedly attaching the second container or drug vial 14 to the gripper assembly 28. The means shown are a plurality of segmented fingers that cooperatively form the finger assembly 92. The finger assembly 92 comprises a plurality of alternating segmented fingers 98a, 98b that are connected at their bottom portions. The wall portion 90 has a ledge 97. The bottom portions of the fingers 98 have corresponding structure to the ledge 97. The finger assembly 92 is bonded to the wall portion 90 proximal this area.

The fingers 98a are spaced inwardly from the wall portion 90 to allow the fingers 98a to flex when a drug vial 14 is inserted into the gripper assembly 28. The fingers 98b have a rear portion contacting the wall portion 90 and generally do not flex as will be described in greater detail below. The fingers 98a, 98b are generally trapezoidal in shape and are separated by gaps to define a vial receiving chamber that corresponds to the central opening 96 of the gripper assembly 28 for receiving a top of the vial 14. Though the present device utilizes six fingers 98a, 98b, it can be appreciated by one of ordinary skill in the art that more or fewer fingers could be utilized without departing from the scope of the present embodiments. For example, eight fingers could be used.

What is meant by “fixedly attached” is that in order to remove the vial 14 from the connector 10, one would have to exert a force considerably in excess of that normally used to operate the device 10. Such a force likely would break, detach or noticeably deform one or more of the segmented fingers 98 or other portions of the connector 10 in the process.

As further shown in FIG. 1, three of the fingers 98a include radially inwardly tapering resilient tabs 104, from a distal end to a proximal end, past which the medical professional must urge a neck of the drug vial 14 in order to connect it to the gripper assembly 28. The tabs 104 are configured such that a space 105 is maintained between the tab 104 and the finger 98a. It is appreciated that the tabs 104 are capable of flexing to accommodate varying diameter vial closures. Preferably, the distal end of the fingers 98 have a radiused end that is smooth to avoid cutting the medical personnel handling the connector 10. The tabs 104 could also be formed, however, as solid bumps without departing from the embodiment.

As also shown in FIG. 1, the remaining fingers 98b (one shown) have axially extending, standing ribs 106 extending along an inner surface of the fingers 98b. The standing ribs 106 extend proximate a bottom portion of the finger but do not contact the base 91 of the gripper assembly 28. The ribs 106 are spaced from the base by the sealing member 84. In a preferred form, the standing ribs 106 assist in aligning the vial 14 with the vial receiving chamber during insertion. The standing ribs 106 are capable of indenting one or more sidewall portions of the metal crimp ring 22 of the vial 14 in order to inhibit the vial 14 from rotating. While one standing rib 106 is shown on each finger 98b, a pair of standing ribs 106 on each finger 98b could also be utilized to enhance the prevention of rotation of the vial 14. The fingers 98b have a post 107 on a rear portion that contacts the wall portion 90. Thus, when the vial 14 is inserted into the gripper assembly 28, the fingers 98b flex very little, if any, while the fingers 98a do flex as the fingers 98a are spaced inward from the wall portion 90. It is desirable for the fingers 98b not to flex in order to maximize the ability of the standing ribs 106 to indent the side of the crimp ring 22 and prevent rotation of the vial 14.

As further shown in FIG. 1, the fingers 98b having the standing ribs 106 are slightly taller than the fingers 98a with the tabs 104. The fingers 98b have a flat lead-in section 99. The flat lead-in section 99 helps to properly align the vial 14 as it is inserted into the gripper assembly 28. Because the fingers 98b are taller than the fingers 98a, the vial 14 is aligned by the lead-in sections 99 and then contacts the tabs 104 as the vial 14 is further inserted into the gripper assembly 28.

While three fingers 98a with resilient tabs 104 and three fingers 98b with standing ribs 106 is preferred, providing more or fewer fingers with resilient tabs 104 or standing ribs 106 would not depart from the scope of the embodiment. It is also preferable that the fingers 98a with the tabs 104 and the fingers 98b with the standing ribs 106 are disposed in alternating order. It may also be desirable to place a flexible restraining member, such as shrink wrap or the like, around the fingers 98a, 98b to assist in gripping the vial 14.

The wall portion 90 further has a first annular rim 108 extending from the base 91. The finger assembly 92 has a bottom portion 93, or base portion, having a second annular rim 110 extending therefrom and towards the first annular rim 108. The second annular rim 110 is coradial with the first annular rim 103 and is longitudinally displaced therefrom. The rims 108, 110 cooperate with the sealing member 84 to be described in greater detail below. In other embodiments disclosed herein, the base portion 93 of the finger assembly 92 could be substantially planar to cooperate with a substantially planar surface of a respective sealing member 84. The finger assembly 92 is ultrasonically welded to the inner surface of the wall portion 90. In this manner, the sealing member 84 is positioned between the base 91 of the wall portion 90 and the bottom portion 93 of the finger assembly 92 wherein the sealing member 84 hermetically seals the central passageway 35 and the piercing member 26 disposed therein.

As further shown in FIGS. 1 and 2, the sealing member 84, sometimes referred to as a septum 84, or vial septum 84, is positioned within the gripper assembly 28. In a preferred embodiment, the sealing member 84 has a base 111 and an annular ridge 112. The base has first and second surfaces. The base is preferably disk-shaped. The annular ridge 112 extends axially from the disk and towards the top of the vial 14. The annular ridge 112 is dimensioned to tightly and sealingly fit over the rubber stopper 20 of the vial 14 to prevent leakage from the vial 14. In a preferred embodiment, the annular ridge 112 tapers axially-outwardly. In addition, the annular ridge 112 of the sealing member 84 is capable of deforming to accommodate dimensional variations in a height of a closure of the second container. The sealing member 84 can be pre-slit at a central location corresponding to the end 80 of the piercing member 76. In one preferred embodiment, the sealing member 84 has a center hub 114 having a thickened cross-section as shown in FIG. 1. The center hub 114 is positioned to be pierced by the piercing member 76 during activation of the device 10. In one preferred embodiment, the piercing member 76 is buried into the thickened center hub 114, without passing through the hub 114, as the plastic spike 83 pierces into the container 12. FIG. 5 shows the sealing member 84 having a thickened center hub 114a that is slightly thinner than the center hub 114 shown in FIG. 1. The disk-shaped sealing member 84 has a web 85 of thinner cross-section than the center hub 114. The web 85 assists the hub 114 in flexing to accommodate dimensional variations in the vial 14. The annular ridge 112 is positioned circumjacent the center hub 114 and the web 85. A first annular groove 113 is positioned at an outer periphery of the sealing member 84 on a first side of the sealing member 84. A second annular groove 115 is positioned on a second side of the sealing member 84 generally opposite annular groove 115. When the device is assembled, the first annular groove 113 receives the first annular rim 108 and the second annular groove 115 receives the second annular rim 110 wherein the sealing member 84 is sandwiched between the base 91 and the bottom portion 93 of the finger assembly 92. In this configuration, the sealing member 84 hermetically seals the passageway 35 and sealing member 76 at the second end 50 of the second sleeve 34. In one form, the sealing member 84 can be sized slightly larger such that when the annular grooves 113, 115 receive the annular rims 108, 110, the sealing member 84 is subjected to a radial compressive force. This assists the sealing member 84 is accounting for dimensional variations of vials 14 that are inserted into the gripper assembly 28. Also, the sealing member 84 can be lubricated, which lubricates the piercing member 76 allowing it to enter the drug vial 14 more easily. The scaling member 84 is preferably made from silicone rubber.

In an alternative embodiment, the sealing member 84 could have a central opening. The central opening receives the piercing member 76 when the connector 10 is moved from its inactivated position to the activated position. The central opening would also allow for steam sterilization past the sealing member 84.

As also shown in FIGS. 1 and 2, the wall portion 90 has a lip 122 at its outer periphery. An end cap, or flip cap 124 is dimensioned to snap over the lip 122 to seal the gripper assembly 28 before a vial 14 is inserted into the gripper assembly 28. No orientation of the end cap 124 is required. The lip 122 is preferably integrally molded with the wall portion 90. The end cap 124 is preferably made from plastic or other suitable material. The end cap 124 provides a hermetic seal between the exterior of the device 10 and the central opening 96. A tape strip (not shown) could be stretched across the end cap 124 and attached to outer surfaces of the wall portion 90 as a tamper evident feature.

Alternatively, a seal material can be releasably secured to the wall portion 90 such as by heat sealing wherein the material can be peeled away by pulling a tab formed on the seal material. The wall portion 90 provides for a solid surface to mount the seal material therefore hermetically sealing the connector 10. The seal material can be made of aluminum foil, or of polymeric based material such as TYVEK.®, and more preferably TYVEK.®. grade 1073B, or spun paper or other material that is capable of being peelably attached to the wall portion 90 and capable of providing a barrier to the ingress of contaminants. It is also contemplated that sealing can be accomplished through induction welding or other sealing techniques.

FIGS. 1-3 show the port connector assembly 30 of the device 10. The port connector assembly 30 serves as a first attaching member to connect the first container 12 to the device 10. It is understood that the port connector assembly 30 could be considered as part of, or associated with, the first sleeve 32. The first sleeve 32 could also be configured to be directly attached to the first container 12. The port connector assembly 30 generally includes a first attaching element 124, generally in the form of a port snap 124, and a second attaching element 127, generally in the form of a container sleeve 127 or membrane tube 127, and also a port septum 136. The container sleeve 127 is generally cylindrical and has one end closed by a membrane 128. The port snap 124 is also generally cylindrical and dimensioned to receive the container sleeve 127. The port snap 124 has a flange 130 extending around its outer surface. A distal end of the port snap 124 has a generally circular, tapered finger 132 extending therefrom. The port snap 124 further has a circular ledge 131 extending radially outwardly from the port snap 124. The ledge 131 is sized to be engaged by fingers of a user during the activation process as described in greater detail below.

The container sleeve 127 is inserted into the port snap 124 and connected thereto preferably by solvent bonding an outer surface of the sleeve 127 to an inner surface of the port snap 124, thus forming a port connector sub-assembly. The membrane 128 of the sleeve 127 is positioned at the flange end of the port snap 124. As shown in FIGS. 1-3, before connecting the port connector assembly 30 to the second end 36 of the first sleeve 32, the port septum 136, a second sealing member, preferably in the form of a rubber septum, is inserted into the second end 36 of the first sleeve 32. The second sealing member 136 is positioned adjacent the guide 44 wherein the projection 47 indents the second sealing member 136. If desired, the port septum 136 could be pre-slit. The second sealing member 136 prevents “drip-back” after the deactivation procedure as will be described in greater detail below. The port snap 124 is then inserted and urged into the first sleeve 32 wherein the flange 130 passes by the protrusion 49 of the first sleeve 32. The resiliency of the materials allow the flange 130 to snap back after passing by the protrusion 49 wherein a tight interference fit is formed between the port connector 30 and the first sleeve 32. Once inserted, the tapered finger 132 indents the second sealing member 136, thus sandwiching the second sealing member 136 between the guide 44 and the port snap 124.

As shown in FIG. 4, the port connector assembly 30 is also connected to the first container 12 wherein the outer surface of the container sleeve 127 is connected to an inside surface of the container port 16, preferably by solvent boding.

In one preferred embodiment, the overall connection between the first container 12 and first sleeve 31 via the port connector assembly 30 is performed using an electron-beam process as disclosed in commonly-assigned U.S. patent application Ser. No. 09/294,964 entitled “Method and Apparatus For Manipulating Pre-Sterilized Components In An Active Sterile Field,” which is expressly incorporated herein by reference. Other methods of connection are also possible such as solvent bonding.

It is understood that in a preferred embodiment, the protrusion 49 and flange 130 are formed around a full periphery of the first sleeve 32 and port snap 124 respectively. These structures can also be in the form of an interrupted annular ridge, a plurality of bumps or even a single bump.

Typically, the connector 10 is connected to the flexible bag 12 prior to shipping. It will be appreciated by one of ordinary skill in the art, however, that the connector 10 could be connected to the first container 12 at different times.

In another embodiment, it is understood that the flexible bag 12 can be pre-attached to a portion of the port connector assembly 30 wherein further connection to the connector 10 is performed in a separate manufacturing process. This separate manufacturing process may be performed at a separate time. For example, in a first process, the port snap 127 is solvent bonded to the membrane tube 127. The flexible bag 12 is filled with the appropriate diluent. The membrane tube 127, with attached port snap 124, is then solvent bonded to the container port 16 of the flexible bag 12. It is understood that the flexible container 12 is then sealed because the membrane 128 of the membrane tube 127. This flexible bag subassembly can then be attached to the first sleeve 32, after the port septum 136 is inserted into the first sleeve 32, in a separate manufacturing process. This attachment may preferably be performed using the electron-beam process as described above.

Referring to FIG. 1, the device 10 can optionally include a member such as tamper-evident strip 150, which is preferably made from adhesive material. The tamper-evident strip 150 can be attached at a juncture between the first sleeve 32 and the second sleeve 34 and over the detent 39. The attachment of the tamper-evident strip 150 alone could be configured to prevent premature movement or activation of the sleeves 32,34. Medical personnel must remove the strip 150 in order for the first sleeve 32 and the second sleeve 34 to be capable of relative axial movement. Optionally, the tamper evident strip 150 could be capable of indicating the first and second sleeves 32,34 have been moved axially with respect to one another, rather than preventing such movement, by becoming damaged upon such movement. The tamper-evident strip 150 can also include a flap 152 for removing the tamper evident strip 150. In this manner, the tamper evident strip 150 can indicate to a medical professional that someone has used or tampered with the device 10 by the fact that the tamper evident strip 150 is missing or damaged. The tamper evident strip 150 can take alternative forms as shown in FIG. 21.

FIGS. 1, 2 and 4 show the connector 10 in its inactivated position where the connector 10 is in its most elongated state. In this inactivated position, the stop surface 51 of the first sleeve 32 abuts the stop surface 64 of the second sleeve 34. The hub 70 is maintained between the hub stop surface 69 and the ledge 62. FIGS. 4-7 disclose the activation process for the connector 10. FIG. 4 shows the device 10 connected to the flexible container 12. As shown in FIG. 5, the end cap 124 is first flipped off the gripper assembly 28. The vial 14 is then inserted into the gripper assembly 28 wherein the fingers 98a flex towards the wall portion 90 until the vial 14 passes by the tabs 104 wherein the neck of the vial 14 is positioned between the tabs 104 and the sealing member 84. The standing ribs 106 on the fingers 98b indent a side portion of the crimp ring 22 on the vial 14. Thus, the vial 14 is fixedly attached to the connector 10. As further shown in FIG. 5, the annular ridge 112 of the sealing member 84 forms a fluid tight seal over the top of the vial 14. Thus, a vial 14 can be selectively docked to the connector 10 without piercing the stopper 20 of the vial 14. As further shown in FIG. 5, the second end 80 of the piercing member 76 is positioned close to the center hub 114 of the sealing member 84. This reduces the stroke length or distance the piercing member 76 must travel to pierce the sealing member 84 and the stopper 20 of the drug vial 14.

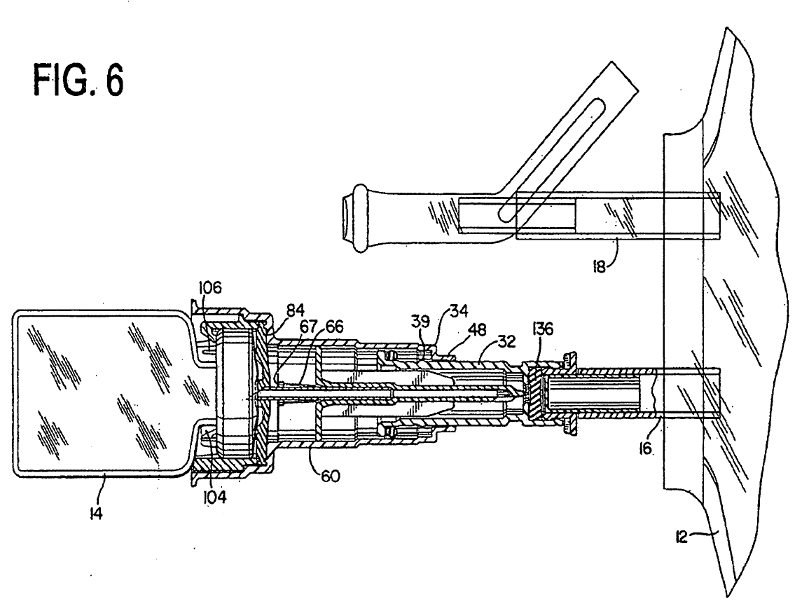

FIG. 6 shows the connector device 10 as the activation process commences. To activate, the tamper-evident strip 150 is first peeled away from the sleeves 32,34. The vial 14 in the gripper assembly 28, along with the second sleeve 34, are moved axially towards the flexible container 12. Adequate force must be applied so that the first end 48 of the second sleeve 34 moves past the detent 39 on the first sleeve 32. As the second sleeve 34 moves along the first sleeve 32, the plastic spike 81 will engage the second sealing member 136. Because of the materials used, the plastic spike 81 will not yet pierce through the second sealing member 136. The friction associated with this engagement will cause the hub 70 to move along the second sleeve 34 wherein the metal cannula 83 will pierce the sealing member 84 and closure of the vial 14. As shown in FIG. 7, as the second sleeve 34 further moves along the first sleeve 32, the stop surface 74 on the first sleeve 32 moves towards and engages the stop surface 86 of the hub 70 on the piercing assembly 76. The hub 70 thus moves along the third section 60 of the second sleeve 34 wherein the hub 70 rides along the ramped protuberances 66 and eventually passes over the flanges 67. This movement forces the metal cannula 83 at the second end 80 of the piercing assembly 76 to pierce completely through the center hub 114 and stopper 22 and thus into the vial 14. The second end 80 of the piercing member 76 now experiences greater friction as it penetrates the stopper 22 of the vial 14. This friction causes the plastic spike 81 at the first end 78 of the piercing member 76 to advance towards the flexible container 12. The plastic spike 81 pierces through the second sealing member 136 and the membrane 128.

As also shown in FIG. 7, the sleeves 32, 34 translate axially wherein the hub 70 advances to against the sealing member 84; also, the first end 48 of the second sleeve 34 proceeds to the first end 36 of the first sleeve 32. This position (FIG. 7) represents the activated position. In the activated position, the metal cannula 83 at the second end 80 of the piercing member 76 is pierced through the stopper 20 of the vial 14, and the plastic spike 81 at the first end 78 of the piercing member 76 is pierced through the second sealing member 136. Thus, fluid communication is established between the flexible bag 12 and the vial 14 through the central fluid passageway 82 of the piercing member 76.

It is understood that when the connector 10 is in the inactivated position, the central passageway 35 is sealed in a substantially air-tight fashion at one end by the sealing member 84, at an opposite end by the second sealing member 136 and at the interface between the sleeves 32, 34 by the sealing member 42. As the vial 14 and second sleeve 34 advance towards the flexible container 12 during the activation process, the volume of the central passageway 35 necessarily decreases thus pressurizing the air located in the central passageway 35. This pressurized air must be relieved before the connector 10 reaches the final activated position. Accordingly, when the o-ring 42 moves past the first section 56 of the second sleeve 34 to the larger diameter of the second section 58 of the second sleeve 34, the sealing member 42 no longer contacts the inner surface of the second sleeve 34 (FIG. 6) thus allowing the pressurized air to be relieved through the junction of the sleeves 32, 34.

In the activated position shown in FIG. 7, the diluent contained in the flexible container 12 can pass through the piercing member 76 to reconstitute the drug contained in the vial 14. Once the drug is reconstituted and the resulting mixture passes completely through the piercing member 76 and into the flexible container 12, the drug vial 14 and second sleeve 34 can be pulled back away from the flexible container 12. As shown in FIG. 8, when the second sleeve 34 is pulled back, the piercing assembly 26 is retained in position by the flange 67 of the ramped protuberance 66. The stop surface 74 of the first sleeve 32, however, does not contact the ramped protuberance 66 and can be retracted. The metal cannula 83 of the piercing member 76 remains in the closure of the vial 14 and the plastic spike 81 of the piercing member 76 is pulled past the membrane 128 and the second sealing member 136 (FIG. 8). This position is referred to as the deactivated position, or post reconstitution position. The second sealing member 136 is resilient and forms a seal once the plastic spike 81 passes by, thus preventing any of the resulting mixture from dripping back into the drug vial 14 or passing into the passageway 35 of the sleeve assembly 24.

The resulting mixture can then be delivered to a patient through appropriate tubing sets (not shown) attached to the second port 18 on the flexible container 12.

### Embodiments of Piercing Assembly Hub

As mentioned above, in an embodiment, there is provided a hub mounted to the piercing member within the means for connecting the vial receiving chamber to the liquid container and a protuberance attached to the means for connecting the vial receiving chamber to the liquid container and dimensioned for allowing movement of the hub from a first position to a second position wherein the hub moves past the protuberance. When the device is moved from the activated position to a deactivated position, the protuberance functions as a detent and restricts the hub from returning to the first position.

As shown as described in reference to FIG. 1, the piercing assembly includes a semi-resilient solid disk, in the form of a hub on the piercing assembly 26. In the embodiment shown in FIGS. 1 and 2, the hub 70 is generally round or disk-shaped. The hub 70 further has an annular outer surface 88 that slides along the inner surface of the second sleeve 34 and specifically along the ramped protrusions 66. The semi-resilient characteristics of the hub allow the hub to be slightly deformed as it is pushed over or past the ramped protuberance 66 and flanges 67. As explained above, as the hub moves past the ramped protuberance 66, the semi-resilient disk or hub is restricted from returning past the flanges 67.

In other embodiments, as described below, the hub is not a solid disk and includes one or more arms, arches, protrusions, indents, cuts or recesses that allow the force required to push the hub past the flanges to be controlled.

### First Embodiment of Piercing Assembly Hub

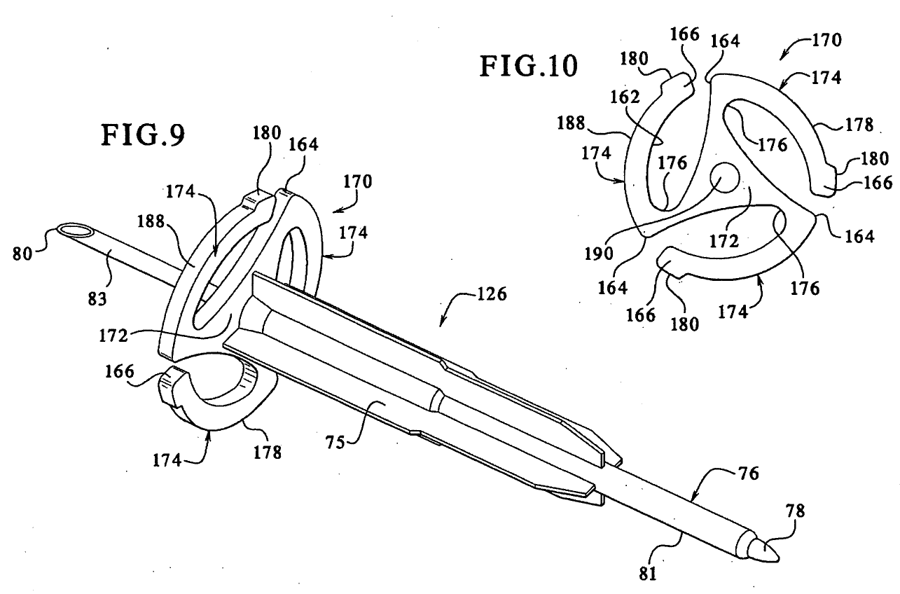

As shown and described in reference to FIGS. 9 and 10, in an embodiment, the hub 170 of the piercing assembly 126 includes a central portion 172 and plurality of arms 174 extending from the central portion 172. The overall shape of the hub 170 is generally disk-shaped, but the hub 170 is not a solid disk as described above in the embodiment shown in FIGS. 1 and 2. The hub 170 of the piercing assembly 126 can be made of plastic, a polymer or polymer blend, or other suitable material that allows the hub 170 to deform slightly as it is pushed over or past the ramped protuberance 66 and flanges 67.

In FIGS. 9 and 10, each of the plurality of arms 174 includes a first portion 176 that extends radially outwardly from the, e.g., triangular, central portion 172 of the hub 170, and a second portion 178 that extends from one side of the first portion 176, circumferentially about the central axis 190. As shown in FIG. 10, each of the second portions 178 of the arms 174 extends away from the first portions 176 in a clockwise direction and has a curved outer surface 188. Curved outer surface 188 can be circular and can slide along the inner surface of the second sleeve 34, e.g., along the ramped protrusions 66 and past flanges 67, as described above with respect to FIGS. 1 and 2. Second portions 178 also include a curved inner surface 162, which can be circular. Arms 174 form gaps between adjacent arms 174 and between the second portion 178 and the central portion 172. Also, each of the second portions 178 includes a proximal end 164 and a distal end 166. As shown best in FIG. 10, the space or gap formed between adjacent arms 174 is formed between a proximal end 164 of one of the arms 174, and a distal end 166 of an adjacent arm 174.

In FIGS. 9 and 10, each of the second portions 178 includes an extension 180 or tab that is configured to engage with a continuous ring flange 67 on the gripper assembly 28 (see, FIG. 1). In one example, the outer diameter of the outer surfaces 188 is equal to or slightly less than the inner diameter of the ring flange 67. Here, the extensions 180 or tabs extend further radially outwardly from the outer surface 188, such that the extensions engage the flange 67. In contrast, the example embodiment of FIGS. 1 and 2 shows the entire outer surface 88 of the hub contacting and being forced over or through the flange 67. In FIGS. 9 and 10 however, a lesser portion of the hub (extensions 180) is pushed through the flange 67. In addition, the cantilevered arms 174, which can bend, provide additional flexibility for the overall hub 170 versus a solid disk without such arms. Accordingly, the force required to push hub 170 of the piercing assembly 126 through the flange 67 is lessened.

It should also be appreciated that although only one extension 180 is shown extending radially from second portion 178 of each arm 174, additional extensions 180 per arm 174 may be used, e.g., to increase holding or retention force. Further, the shape of the extensions 180 may be rectangular, curved, semispherical, generally triangular, or any other suitable shape that allows the extensions to engage with the annular flange 67 in a manner that will provide a suitable holding or retention force. Also, although extensions 180 shown in FIG. 10 are located at a distal end of the second portion 178 of the arms 174, it should be appreciated that the extensions may extend from other suitable locations on the outer surface 188. Positioning extensions 180 closer to distal end 166 makes the snap-fitting of the extension more pliable or easier. Positioning extensions 180 closer to proximal end 164 makes the extensions more rigid and better able to hold piercing assembly 126 and the connector together.

Second portions 178 may extend alternatively in the counterclockwise direction. Second portions 178 may further alternatively extend in both the clockwise and counterclockwise directions from the first portions. Hub 170 may further alternatively include only two arms 174 or more than three arms. Still further alternatively, central portion 172, while shown having a generally triangular shape with slightly concave surfaces, could have another suitable shape depending, for example, on how many arms 174 are provided.

### Second Embodiment of Piercing Assembly Hub

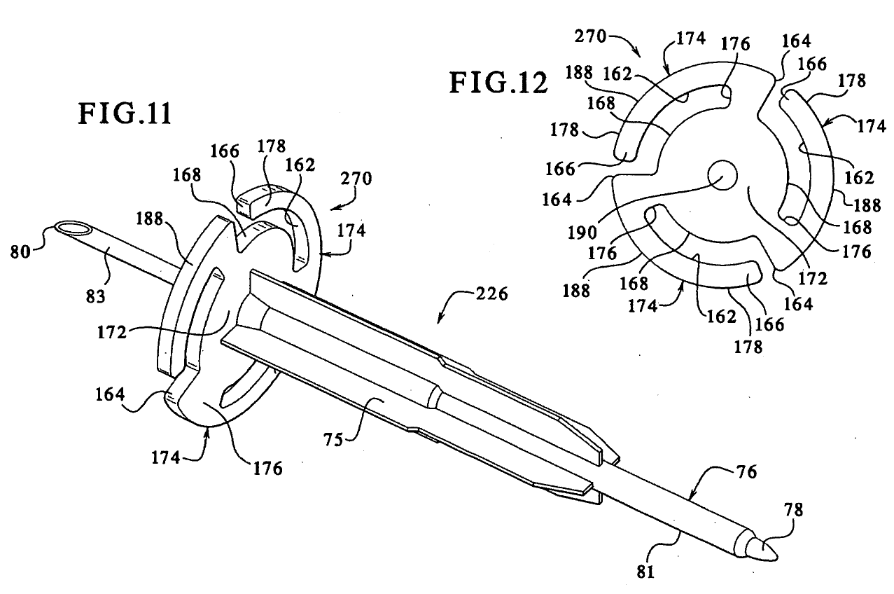

As shown and described in reference to FIGS. 11 and 12, in an embodiment, the hub 270 of the piercing assembly 226 includes a central portion 172 and plurality of arms 174 extending from the central portion 172. As in the embodiment described above with respect to FIGS. 9 and 10, the overall shape of the hub 270 is still generally disk-shaped, but is not a solid disk as described above in the embodiment shown in FIGS. 1 and 2. In this embodiment, the central portion 172 has a circular outer surface 168. The hub 270 of the piercing assembly 226 can be made of plastic, a polymer or polymer blend, or other suitable material that allows the hub 270 to deform slightly as it is pushed over or past the ramped protuberance 66 and flanges 67.

In FIGS. 11 and 12, each of the plurality of arms 174 includes a first portion 176 that extends radially outwardly from the (e.g., circular) central portion 172 of the hub 270, and a second portion 178 that extends from one side of the first portion 176, and circumferentially about the central axis 190. As shown in FIG. 12, each of the second portions 178 of the arms 174 extends away from the first portions 176 in a counterclockwise direction and has a curved outer surface 188. Curved outer surface 188 can be circular and can slide along the inner surface of the second sleeve 34 and, e.g., along the ramped protrusions 66 and past the flanges 67, as described above with respect to FIGS. 1 and 2. Second portions 178 also include a curved inner surface 162, which can also be circular. Outer surface 168 of the central portion 172, the inner surface 162 of the second portion 178 of the arm 174, and the outer surface 188 of the second portion 178 of the arm 174 can be concentric with respect to each other. Arms 174 form a space or gap between the outer surface 168 of the central portion 172 and the inner surface 162 of the second portion 178 of the arm 174 as with the piercing assembly 126.

Second portions 178 may extend alternatively in the clockwise direction. Second portion 178 may further alternatively extend in both the clockwise and counterclockwise directions. Further, hub 270 may include two arms 174 or more than three arms.

In the illustrated embodiment, each of the second portions 178 includes a proximal end 164 and a distal end 166. As shown best in FIG. 12, a space or gap is formed between a proximal end 164 of one of the arms 174, and a distal end 166 of an adjacent arm 174. As seen above in FIGS. 1 and 2, the flange 67 in the second sleeve 34 is an annular ring positioned about the inside of the second sleeve 34. Here, the outer surfaces 188 of the arms 174 interact with the flange 67 in the second sleeve 34. In the embodiments shown in FIGS. 11 and 12, the arms 174 provide an additional measure of flexibility for the hub than that which is obtained with a solid disk. Accordingly, the force required in order to push the hub 270 of the piercing assembly 226 through the flange 67 portion can be reduced. Unlike hub 170, hub 270 does not include a locking extension 180, so the entire outer surface 188 of the arms slides along sleeve protuberances 66 and snaps across flanges 67. Such a configuration increases the holding force and sacrifices ease of movement relative to the piercing assembly 126 of FIGS. 9 and 10. Piercing member 226 is easier to move however than piercing assembly 26 of FIGS. 1 and 2.

### Third Embodiment of a Piercing Assembly Hub

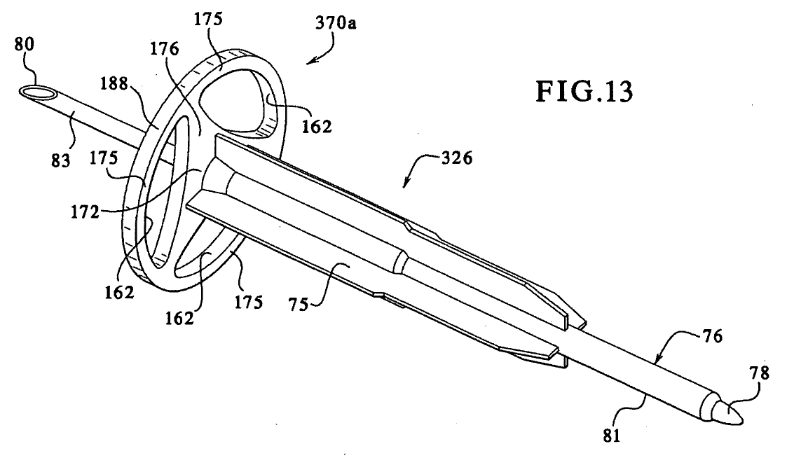

As shown and described in reference to FIGS. 13 to 15, in an embodiment, the hub 370a, 370b of the piercing assembly 326 includes a central portion 172 and a plurality of arches 175 extending about and connected to the central portion 172 (e.g., a generally triangular central portion). As in the embodiment described above with respect to FIGS. 11 and 12, the overall shape of the hub 370a, 370b is generally disk-shaped, but is not a solid disk as described above in the embodiment shown in FIGS. 1 and 2. Here, each of the three arches 175 is centered about the central portion 172 and the central axis 190 of the hub 370a, 370b. Each of the arches 175 is connected to the central portion 172 by first portions 176 that extend radially outwardly from the central portion 172. The hub 370a, 370b of the piercing assembly 326 can be made of plastic, a polymer or polymer blend, or other suitable material that allows the hub 370a, 370b to deform slightly as it is pushed over or past the ramped protuberance 66 and flanges 67.

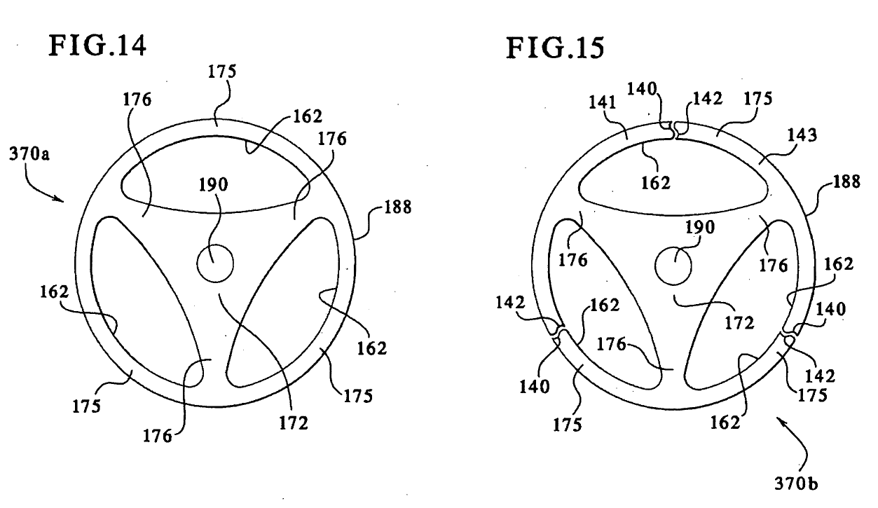

Arches 175 have a curved or circular outer surface 188. However, in contrast to the embodiments described above with respect to FIGS. 9 to 12, the outer curved surfaces 188 of arches 175 collectively form a continuous ring. In FIGS. 14 and 15, there are no gaps or spaces between adjacent arms. Arches 175 also have a curved inner surface 162. Therefore, the combination of the arches 175, the central portion 172 and the extending first portions 176 form a spoke and rim configuration.

In FIGS. 13 and 14, hub 370a of the piercing member 326 slides through the interior portion of the connector. Arches 175 flex as hub 370a travels past ramped protrusions 66 and snaps across flanges 67, as described above with respect to FIGS. 1 and 2. The solid ring increases rigidity and holding force once snapped across flanges 67, sacrificing ease of moving the piercing assembly 326 into the snapped position relative to piercing assembly 126 of FIGS. 9 and 10.

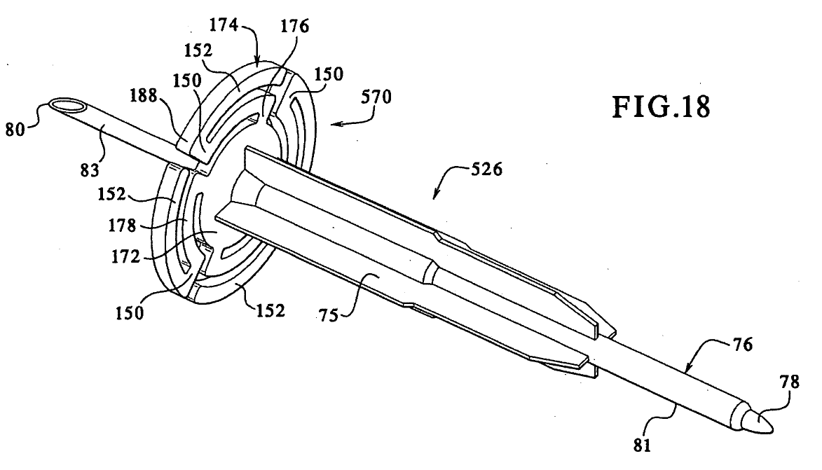

As shown and described in reference to FIG. 15, in an alternative embodiment, the hub 370b is provided with a plurality of arches 175 as in the embodiment of FIGS. 13 and 14. However, in this embodiment, each of the arches 175 is split such that each arch 175 has a portion 143 located clockwise along the arch 175 from a portion 141. The end 140 of the portion 141 and the end 142 of the portion 143 of the arches 175 are interlocking ends. The interlocking ends may form an S configuration as shown in FIG. 18, or may be constructed and arranged in another suitable interlocking arrangement, such as a C or V configuration. Split arches 175 allow additional flexibility. The gap between the arches 175 and central portion 172 allows for radial flexing of the arches 175. The splits in the arches 175 allows for increased axial flexing as one or portions 141 and 143 alone may be bent to snap past a flange 67 of the mating connector.

The arches 175, the spaces between the arches 175, and the central portion 172 form a hub 370b that is more flexible than solid disk hub 70. Accordingly, the force required to push the hub 370b of the piercing assembly 326 past the flanges 67 is reduced.

It should be appreciated that the number of arches may be varied, e.g., two arches or four or more arches. Also, the thickness and inner and outer surfaces of the arches may be varied provided that the outer surface of the arches engages one of the flanges 67 in the second sleeve 34 of the connector.

### Fourth Embodiment of Piercing Assembly Hub

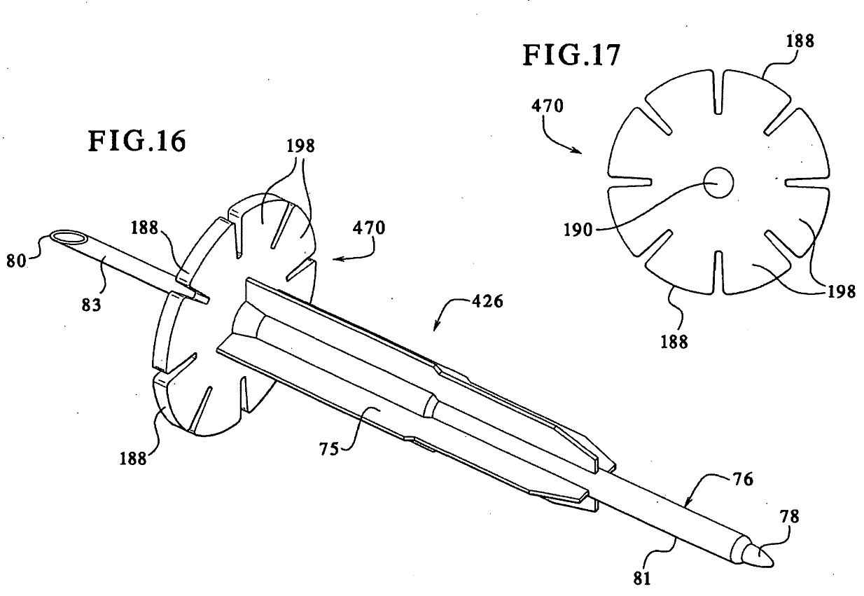

As shown and described in reference to FIGS. 16 and 17, in an embodiment, a further alternative hub 470 of a piercing assembly 426 is substantially disk-shaped and includes a plurality of cuts or recesses or slits that extend radially inwardly from an outer surface 188 of the hub 470. The slits extend radially inwardly from the outer surface 188 a portion of the distance toward the central axis 190. Fingers 198 are formed between successive slits. In the example embodiment shown in FIGS. 16 and 17, the slits extend about half of the distance to the central axis 190. However, it should be appreciated that the number of slits and the depth of the slits may be varied to produce tabs between the slits having a desirable amount of flexibility and retention force. Moreover, it should be appreciated that the slits may be curved and not radially straight as shown. In addition, the slits may extend inwardly at an angle such that the slots would not bisect axis 190, rather than radially inwardly toward axis 190 as shown. The hub 470 of the piercing assembly 426 can be made of plastic, a polymer or polymer blend, or other suitable material that allows the hub 470 to deform slightly as it is pushed over or past the ramped protuberance 66 and flanges 67.

As in the above embodiments, the slits between the respective fingers 198 provide a hub 470 that is more flexible than a solid disk. Accordingly, the force required to push the hub 470 of the piercing assembly 426 through the flange 67 portion is lessened, while still providing a sufficient retention force.

### Fifth Embodiment of Piercing Assembly Hub

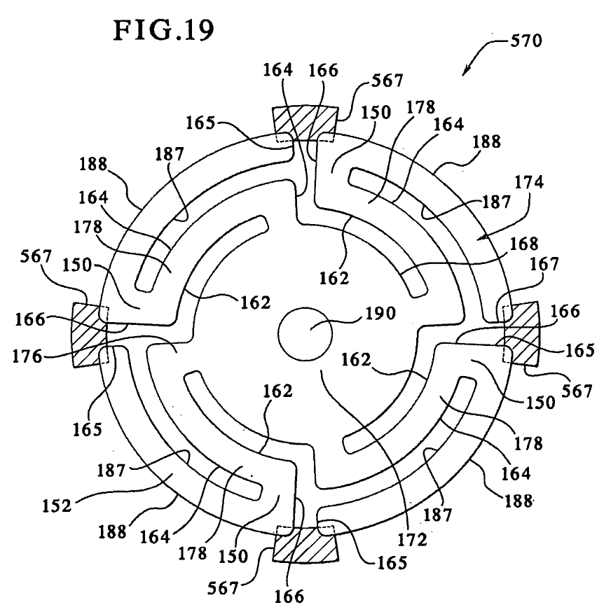

As shown and described in reference to FIGS. 18 and 19, in an embodiment, still a further alternative hub 570 of the piercing assembly 526 includes a central portion 172 and plurality of arms 174 extending from the central portion 172. As shown herein, the overall shape of hub 570 is generally disk-shaped, but is not a solid disk as described above in the embodiment shown in FIGS. 1 and 2. Each of the arms 174 of the hub 570 is arranged in a maze-like configuration, in which each arm 174 includes a first portion, a second portion, a third portion, and a fourth portion. The hub 570 of the piercing assembly 526 can be made of plastic, a polymer or polymer blend, or other suitable material that allows the hub 570 to deform slightly as it is pushed over or past the ramped protuberance 66 and flanges 67.

In FIGS. 18 and 19, the hub 570 includes a central portion 172 having an outer circular surface 168. Each of the plurality of arms 174 includes a first portion 176 that extends radially outwardly from the, e.g., circular central portion 172 of the hub 570, and a second portion 178 that extends from one side of the first portion 176 and circumferential about the central axis 190. As shown in FIG. 18, each of the second portions 178 of the arms 174 extend away from the first portions 176 in a counterclockwise direction and have a curved outer surface. The second portions 178 also include a curved inner surface 162, and a curved outer surface 164. Third portions 150 of the arm 174 extend radially outwardly from a distal end 166 of the second portion 178. Third portions 150 extend radially outwardly from the hub 570 in a similar fashion to the first portions 176 from central portion 172. Fourth portions 152 extend from one side of the third portions 150 and circumferentially about the central axis 190 in a clockwise direction. Fourth portions 152 extend circumferentially about the central axis 190 in a similar fashion to the second portions 178 from first portions 176, but extend in the opposite direction (i.e., extend radially clockwise rather than counterclockwise). Fourth portions 152 include a curved inner surface 187 and a curved outer surface 188, as described above with respect to FIGS. 11 and 12. The hub 570 shown in FIGS. 18 and 19 is accordingly formed having a maze-like pattern or configuration.

The outer surface 168 of the central portion 172, the inner surface 162 of the second portion 178 of the arm 174, the outer surface 164 of the second portion 178, the inner surface 187 and the outer surface 188 of the second portion 178 of the arm 174 are concentric with respect to each other. Arms 174 form gaps between the outer surface 168 of the central portion 172 and the inner surface 162 of the second portion 178 of the arm 174. Another gap is formed between the outer surface 164 of the second portion 178 and the inner surface 187 of the fourth portion 152.

Second portions 178 may extend alternatively radially in the clockwise direction, and the fourth portions 152 may further alternatively extend in the counterclockwise direction. Although the number of arms 174 is shown to be four in FIGS. 18 and 19, hub 570 may alternatively include two or three arms 174 or five or more arms. Also, the arms may be formed in another suitable maze-like pattern, provided that the overall shape of the hub 570 is generally a circular or disk shape. For example, the number and length of the gaps may be optimized in accordance with a desired insertion force past the flanges 67 in the second sleeve 34.

Each of the second portions 178 includes a proximal end 164 and a distal end 166, and each of the fourth portions 152 includes a proximal end 165 and a distal end 167. As shown best in FIG. 19, a space is formed between a proximal end 164 of the second portion 178 and the distal end 167 of the fourth portion, and a distal end 166 of the second portion 178 and the proximal end 165 of the fourth portion of an adjacent arm 174.

In one embodiment as shown in FIGS. 1 and 2, the second sleeve 34 of the connector device 10 includes a continuous ring flange 67. However, the annular flange 67 on the second sleeve 34 may alternatively include a plurality of individual flanges 567 (see, FIG. 19) spaced circumferentially about the inside of the second sleeve 34. In such an embodiment, the outer surfaces 188 of the arms 174 interact with the plurality of flanges 567. In one example, the flanges 567 are spaced about the inside of the second sleeve 34 to correspond to the locations of the spaces defined between the distal end 166 of the second portion 178 and the proximal end 165 of the fourth portion of an adjacent arm 174. In this example, the width of the spaces is less than the width of the flanges 567.

In the embodiments shown in FIGS. 18 and 19, the arms 174 provide an additional measure of flexibility for the hub 570 than that which is obtained with a solid disk. Accordingly, the force required in order to push the hub 570 of the piercing assembly 126 through the flange 67 portion can be reduced.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A piercing assembly for fluidly connecting a first container to a second container and slidable within a connector housing, said piercing assembly comprising:
a piercing member; and
a hub supporting the piercing member, the hub including a central portion and a plurality of arms extending from the central portion, the arms deforming upon engagement with at least one flange extending inwardly inside the connector housing.

2. The piercing assembly of claim 1, wherein the connector housing is tubular and each of the arms has a curved outer surface that enables the flange to slide within the tubular connector housing.

3. The piercing assembly of claim 2, wherein the tubular connector housing includes an inwardly extending flange, and each of the arms is sized so that at least a portion of the arms are engageable with the annular flange.

4. The piercing assembly of claim 1, wherein each of the arms includes a curved outer surface and a curved inner surface.

5. The piercing assembly of claim 1, wherein each of the arms is formed in a generally S-shaped configuration.

6. The piercing assembly of claim 1, wherein each of the arms includes a first arm portion extending radially outwardly from the central portion of the hub, and a second arm portion extending from an end of the first arm portion.

7. The piercing assembly of claim 6, wherein each of the second arm portions includes an outer curved surface and extends circumferentially about a central axis.

8. The piercing assembly of claim 7, wherein each of the second portions includes at least one protuberance that is engageable with the flange of the connector housing.

9. The piercing assembly of claim 1, wherein the hub is a flat disk, and the arms of the hub are defined by a plurality of slits formed in an outer circular edge of the disk.

10. The piercing assembly of claim 9, wherein each of the slits extends radially inwardly from the outer circular edge of the disk.

11. A piercing assembly for fluidly connecting a first container to a second container and slidable within a connector housing, said piercing assembly comprising:
a piercing member; and
a hub supporting the piercing member, the hub including a central portion and a plurality of arches extending radially outwardly from the central portion, the arches defining an outer circular perimeter of the hub and deforming upon engagement with at least one flange inside the connector housing.

12. The piercing assembly of claim 11, wherein each the arches include first and second arch portions, the first arch portion mating with the second arch portion.

13. A connector for establishing fluid communication between a first container and a second container, said connector comprising:
a first sleeve adapted to be connected to the first container and including at least one flange;
a second sleeve adapted to be connected to the second container and slidably connected to the first sleeve; and
a piercing assembly slidably positioned in the sleeves, the piercing assembly including a piercing member and a hub supporting the piercing member, the hub including a plurality of arms,
wherein at least one of the arms is configured to cooperate with the at least one flange of the first sleeve.

14. The piercing assembly of claim 13, wherein the flange is an annular flange formed on an inside surface of the first sleeve, and each of the arms is configured to cooperate with the annular flange.

15. The piercing assembly of claim 13, wherein each of the arms has an outer curved surface that enable the hub to slide within the sleeves.

16. The piercing assembly of claim 15, wherein each of the arms has a shape selected from the group consisting of: a curved shape; a maze-like shape, and a rectangular shape.

17. The connector of claim 13, wherein the piercing member defines a fluid pathway.

18. The connector of claim 17, wherein the fluid pathway is configured to provide a fluid flow path between the first container and the second container when the connector is in an activated position.
